(19) United States
(12) Patent Application Publication
(10) Pub. No.: US 2007/0191257 A1
(43) Pub. Date: Aug. 16, 2007

(54) Method and device for producing fragrance and/or aroma compositions

(76) Inventors: Carlo Andretta, Uitikon-Waldegg (CH); Michele Bomio, Birmensdorf (CH)

Correspondence Address: COHEN, PONTANI, LIEBERMAN & PAVANE, 551 FIFTH AVENUE, SUITE 1210, NEW YORK, NY, 10176, US

(21) Appl. No.: 10/589,310

(22) PCT Filed: Feb. 14, 2005
(86) PCT No.: PCT/CH05/00081

§ 371 Date: Jan. 17, 2007

(51) Int. Cl. A61Q 13/00

(52) U.S. Cl. 512/1; 700/266

(57) ABSTRACT

The invention relates to a method for producing a fragrance and/or aroma composition using a composition database that contains recipe vectors and attribute vectors associated with groups of base compositions. According to the inventive method a target attribute vector is defined, an operator effecting the transformation of recipe vectors to attribute vectors in at least one surrounding of the target attribute vector is determined, a target recipe vector is determined under the proviso that it is transformed to the target attribute factor using said operator, and defined substance components are mixed with one another in proportions according to the target recipe vector.

### TECHNICAL FIELD

The invention relates to a method for producing fragrance and/or aroma compositions, as well as to a device for carrying out this method.

### State of the Art

In the field of perfume and flavor making, there is a constant need for new or modified fragrances and aromas, respectively, which have to meet the most diverse demands. The general problems in this regard are described for instance in DE 101 44 816 A1. The search for appropriate fragrances and aromas is made difficult particularly due to the fact that the relations between the perception of fragrance and aroma, respectively, and the chemical structure of the scent and flavoring substance are not sufficiently known. Furthermore, it is found that minor changes in the structural composition of known scents and flavoring substances can often produce strong changes of the respective olfactory and flavor characteristics. The relations in the commonly used fragrance and aroma compositions, which consist of a mixture of multiple scents and flavoring substances, are even more complex.

EP 1 271 140 A1 describes a method to determine sensory attributes of food with a disperse lipid phase. A sample of the food is thereby brought into an environment which, to the extent possible, corresponds to the conditions in the mouth during the intake of food. Thereupon, a prediction of the sensory attributes is made on the basis of the spatial distribution of the lipid phase under these conditions.

However, it is not possible to make a general prediction of the sensory characteristics of fragrance and aroma compositions. In addition, EP 1 271 140 A1 does not address the questions of handling known sensory attributes in view of their practical use, particularly for the manufacturing of new creations which come as close as possible to a predetermined sensory profile, which are raised in the field of fragrance and flavor making.

Different evaluation instruments have been developed a while ago in order to objectify as much as possible the complex impressions and relations used in quantifying sensory characteristics. Quantitative descriptive analysis (QDA), which was introduced around 1974, was further developed as a result thereof, for instance to the so-called QFP-method (“Quantitative Flavor Profiling”), see XP008033289 (C. R. Stampanoni, Quantitative flavor profiling. An effective tool in flavor perception. Food Marketing and Technology 1993, Sensory Dep. Glvaudan-Roure Flavors Ltd., Dëndorf, Switzerland, Vol. 7, no. 1, Feb. 1993, p. 4-8). Such methods do allow for a mostly independent evaluation and description of fragrance and/or aroma compositions by the test subjects used; however, a conversion of this methodology to an operationally clearly defined concept for the development and production of new fragrance and/or aroma compositions (hereinafter also jointly referred to as “compositions”) has not been described up to now.

### REPRESENTATION OF THE INVENTION

The object of the invention is to specify a method for producing fragrance and/or aroma compositions by means of which the above disadvantages and restrictions are avoided. This task is solved by the method defined in claim 1 and by the device defined in claim 9 according to the invention.

According to the method of this invention, one starts with a composition database that is comprised of a number of recipe vectors and attribute vectors associated to a group of base compositions. Each one of said base compositions can be manufactured by mixing predetermined substance components, wherein the proportions of the individual substance components are represented by a corresponding recipe vector. Furthermore, evaluation results with regard to the characteristics of the selected sensory attributes of the base compositions are available and are represented in the form of associated attribute vectors for each one of the base compositions. The method according to the invention consists of the following steps:
a) specifying a target attribute vector;
b) determining an operator which effects a transformation from recipe vectors to attribute vectors at least in a surrounding of the target attribute vector;
c) establishing a target recipe vector with the proviso that it is transformed to a target attribute vector by using said operator;
d) mixing the specified substance components with proportions according to the target recipe vector.

In the present context, the solvents, carrier substances and the like, which are required depending on their use, can also be regarded as “substance components” in addition to the various fragrance and/or aroma substances. p An ordered series of numeric values which specifies the proportions of the substance components that are used to create fragrance and/or aroma composition will be regarded as a “recipe vector”. The m-th component (in algebraic sense) of the recipe vector of the n-th composition indicates which proportion the substance component “m” exhibits in said composition “n”.

The “attribute vector” can, analogously to the recipe vectors, be represented as an ordered series of numeric values which specify the numeric evaluation results of the individual sensory attributes.

The method according to the invention uses a composition database comprising information for a group of base compositions, whereby the composition—expressed in the form of the recipe vector—on the one hand, and the sensory attributes—expressed in the form of the attribute vector—on the other hand, are stored for each base composition.

A fragrance and/or aroma composition can be produced with a desired attribute characteristic on the basis of this composition database. The desired and intended sensory attributes are thereby represented in the form of an ordered series of numeric values which is designated as “target attribute vector” and which indicates the desired numeric values of the individual sensory attributes. As a result thereof, a “target recipe vector” is to be determined which is to be regarded as mixture instruction for the sought-after composition. For this purpose, at least the attribute vectors that have already been stored in the composition database and that are closest to the modified attribute vectors, and for which, as a result, an associated recipe vector is known, are consulted. Based on the known relation between these attribute vectors and recipe vectors, an operator is established, which effects a transformation from recipe vectors to attribute vectors at least in a surrounding of the modified attribute vector. Subsequently, the target recipe vector is sought after whereby it should have the characteristic that it can be transformed to the desired target attribute vector by using the previously established operator. Finally, the sought-after composition is created by mixing the specified substance components with proportions according to the target recipe vector.

In the present context, a method for the production of compositions is addressed which can be used particularly for the creation of a new and not yet known composition. However, “production” can also be regarded as “modification” of an already characterized composition, since the method is based on a composition database with information on a number of base compositions, i.e. an attribute vector of one of the base compositions will often be used and modified in a desired direction when specifying the target attribute vector. The terms “production” and “modification” are hereinafter used as equivalents against this background.

An additional object of the invention is to specify a device for carrying out the method according to the invention. This task is solved by the device defined in claim 9. The device according to the invention features a data processing unit, as well as a mixing device controlled by it, wherein the data processing unit comprises means for the entry, storage and retrieval of at least one composition database, as well as means for the determination of imaging operators, means for the entry of attribute vectors, means for the calculation of modified recipe vectors and means for the transfer of control signals, which are shaped according to the recipe vectors, to the mixing device.

The mixing device features the following components:
a) a plurality of storage containers that can be filled with individual substance components;
b) a plurality of receptacles;
c) a controllable feeding device to bring specified quantities of individual substance components from the corresponding storage containers to the receptacles in order to create a fragrance and/or aroma composition.

Advantageous embodiments of the invention are defined in the dependent claims.

A preferred manner to produce the composition database is defined in claim 2, which comprises the following procedural steps:
a) preparing the group of base compositions by mixing the substance components in proportions according to each recipe vector associated to a base composition.
b) quantitatively evaluating each base composition with regard to the selected sensory attributes and creation of the associated attribute vector; and
c) creating the composition database by storing the recipe vectors and attribute vectors in such a way that the vectors, which are associated to each base composition, are available in relation to one another and to the base composition.

Due to the fact that the vectors that are associated to each composition, are available in relation to one another and to the composition, the highly complex relations between the composition and the sensory attributes of fragrance and/or aroma compositions can be measured in a systematic manner and are available for further analyses.

As is generally known, the evaluation of sensory attributes of fragrance and/or aroma compositions is made difficult due to the fact that a sensory evaluation by individual persons often shows considerable anomalies on the basis of subject influential factors. Hence, it is preferable to use a qualifiable procedure. This can be carried out by means of quantitative descriptive analysis according to claim 3.

Advantageously, only a selected part of the attributes emanating from the quantitative evaluation is used for the creation of the attribute vector. These attributes are advantageously selected by means of a factor analysis according to claim 4.

The establishment of an operator that effects a transformation from recipe vectors to attribute vectors can be made difficult due to the fact that a plurality of very different recipes may lead to compositions with very similar sensory attributes. Hence, the method according to claim 5 is advantageously used, wherein the bijective relation between attribute and recipe vectors of the composition database is used by means of multiple regression and/or neuronal networks and/or expert system, in order to establish the sought-after operator based on the local situation in the surrounding of a modified attribute vector.

When preparing a group of fragrance and/or aroma compositions, it is appropriate to construct a series of compositions with slightly different sensory attributes through selective addition of substance components based on a few substance components serving as basis, which define an excellent fragrance and flavor note. Essentially, different procedures can be applied for this. This can be advantageously executed by means of statistical test planning according to claim 6. A device designed for this purpose is defined in claim 9. The means that are thereby provided for the production of recipe vectors can be created in particular by a programmable recipe module, which is equipped with means for data entry, data processing and data output, as well as with means of storage, namely to store the produced recipe vectors in the scope of the composition database.

A corresponding attribute vector is advantageously specified, which can be particularly regarded as modification of an attribute vector that is already available in the composition database, for the search of a composition with desired sensory attributes. The modification can particularly consist of the fact that a certain attribute should be strengthened or weakened. Such a modification is advantageously carried out in an interactive manner based on appropriate visualization and entry means, for instance through a monitor or computer mouse and the like. Inasmuch as the desire exists to reproduce a predetermined fragrance and/or aroma composition of an unknown composition, a modified attribute vector can be determined, according to claim 7, by the fact that an attribute analysis, for instance by means of quantitative descriptive analysis according to claim 3, can be carried out for said composition.

The most diverse types of graphic renditions are possible to visualize and process attribute vectors. The attribute vectors are advantageously represented in the form of polar diagrams, particularly so-called “spider webs” according to claim 8. A beam section that emanates from a mutual center, the length of which is a measurement for the specification of the attribute in question, is associated to each attribute. Advantageously, the beams are arranged at equidistant angles.

### BRIEF DESCRIPTION OF THE DRAWINGS

Working examples of the invention are hereinafter described in more detail on the basis of the drawings which show:

FIG. 1 a schematic view of a device to produce fragrance and/or aroma compositions;

FIG. 2 a schematic view of the procedure in developing a module;

FIG. 3 a schematic view of six compositions in a plane spanned by two attributes a and b;

FIG. 4 a schematic view of the determination of relations between the proportions of substance components and the attribute characteristics of a composition;

FIG. 5 a graphic view of the relation between the specification of the “peach aroma” and the proportion of the substance components “butylacetate” and relevant regression lines.

FIG. 6 a view of the attribute vector of a composition as polar diagram.

### MODES FOR CARRYING OUT THE INVENTION

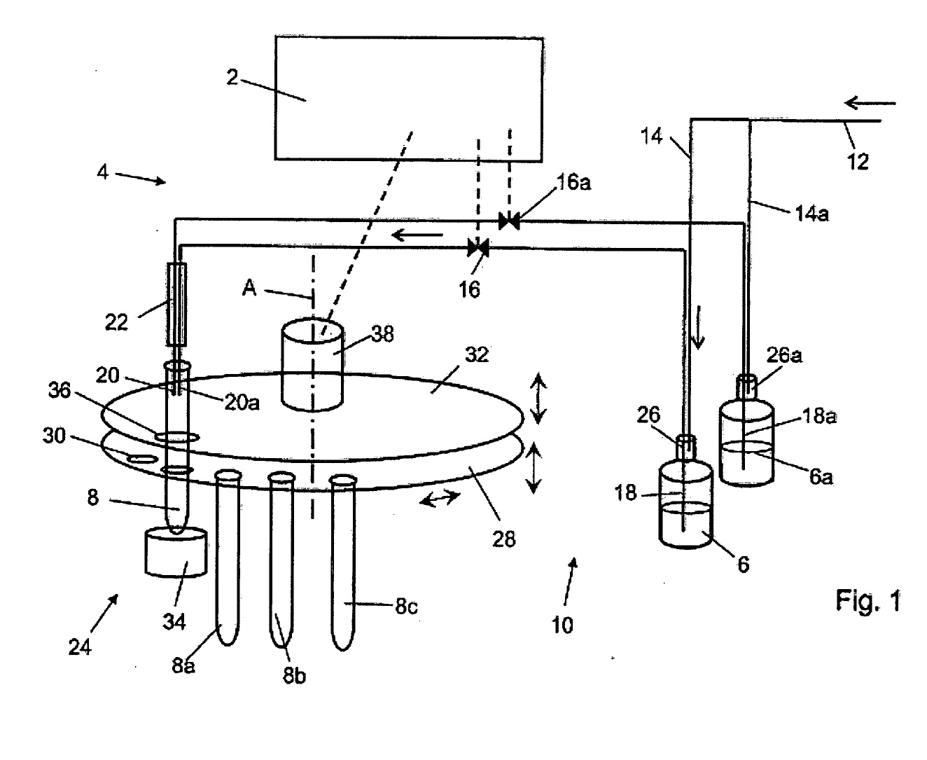

The device displayed in FIG. 1 for the production of fragrance and/or aroma compositions comprises a data processing unit 2 and a mixing device 4 that is controlled by it. Mixing device 4 features a plurality of storage containers 6, 6a, etc. that can be filled with individual substance components—for instance small glass bottles—as well as a plurality of receptacles 8, 8a, 8b, 8c, etc.—for instance reagent glasses—for fragrance and/or aroma compositions.

A controllable feeding device 10 comprises a pressure gas pipe 12 that is supplied by a pressure gas source and is not displayed, and from which feeding pipes 14, 14a, etc., which lead to the individual storage containers 6, 6a, etc. are diverged. Furthermore, each storage container 6, 6a, etc. is equipped with a riser duct 18, 18a, etc., which essentially ranges down to the bottom of the storage container concerned. The individual riser ducts 18, 18a, etc. are bundled at their distal ends 20, 20a, etc., located away from the storage containers towards a filing arm 22 that belongs to a filling station 24. In addition, each riser duct 18, 18a, etc. contains a controllable valve 16, 16a, etc. Feeding pipe 14, 14a, etc. and riser duct 18, 18a, etc. of each of these storage containers 6, 6a, etc. run through a container lid 26, 26a, etc., which creates a pressurized seal. Corresponding valve 16 in riser duct 18 is opened in order to let a certain quantity of the substance components contained in a storage container 6 go to a receptacle 8. The excess pressure in storage container 6 causes the substance components to be pressed in riser duct 18 through valve 16 and all the way up to filling arm 22.

Furthermore, mixing device 4 comprises an essentially horizontally arranged turntable 28, the periphery of which is provided with a plurality of openings 30 that are distributed across the extent thereof. As is evident from FIG. 1, the individual receptacles 8, 8a, 8b, 8c hang on turntable 28 in the individual openings 30. For this purpose, the receptacles 8, 8a, 8b, 8c, etc. feature an upper collar that surpasses the width of openings 30 and so that a supporting surface is created for the suspended storage of receptacles 8, 8a, 8b, 8c, etc. Turntable 28 can be rotated on its central axis A and, in addition, can be shifted to an upper position by the lower position in axial direction displayed here. A cover disc 32, which is essentially coaxially located above turntable 28, creates an upper cover for receptacles 8, 8a, 8b, 8c, etc. hanging in turntable 28; however, cover disc 32 is displayed in FIG. 1 as somewhat raised compared to turntable 28 for reasons of clearness.

Additionally, filling station 24 contains a weighing device 34 by means of which the quantities of the different substance components that are fed to a receptacle 8 that is placed on top of it can be exactly determined. As is evident from FIG. 1, filling arm 22, receptacle 8 to be filled and weighing device 34 are essentially vertically positioned one below the other. A gap 36 in cover disc 32 leaves free a passage for the receptacles 8 placed on weighing device 34.

Following the successful filling of receptacle 8, cover disc 32 and filling arm 22 are initially raised until receptacle 8 is released; in addition, turntable 28 is raised until receptacle 8 is hanging off of it. Subsequently, turntable 28 is rotated around central axis A to the extent until the next receptacle 8a to be filled is located above weighing device 24.

Afterwards, turntable 28 is lowered, as a result of which receptacle 8a will come to stand on weighing device 24. Finally, cover disc 32 is lowered to the upper parts of receptacles 8, 8b, 8c, etc. hanging in turntable 28; furthermore, filling arm 22 is again lowered to such an extent that distal ends 20, 20a, etc. of riser ducts 18, 18a, etc. are located inside or nearly inside of the mouthpiece of receptacle 8a which can be filled henceforth.

The previously described motions of turntable 28, filling arm 22 and cover disc 32 are effected by a simple schematically represented traction group 38 that is controlled by data processing unit 2.

It is appropriate to provide for different exchangeable turntables. A first turntable can for instance be provided for 64 smaller containers, which can be filled up to 20 g, and a second turntable for 28 bigger containers, which can be filled up to 100 g.

The device is advantageously comprised of multiple, for instance four filling stations and a corresponding number of weighing devices, filling arms, valve groups, etc., as a result of which the filling of a larger number of receptacles can be accelerated accordingly.

Data processing unit 2 features known function groups such as computers, storage media, monitors, computer mouse which are used for the entry, storage, processing and retrieval of data. As is further clarified hereinafter based on the relevant procedural steps, data processing unit 2 comprises in particular . . . means to enter, store, process and retrieve at least one composition database, as well as means for the determination of imaging operators, means for the entry of attribute vectors, means for the calculation of modified recipe vectors and means for the transfer of control signals, which are shaped according to the recipe vectors, to mixing device 4.

Recipes and sensory data of fragrance and/or aroma compositions—hereinafter referred to as “compositions”—are managed with the device described above. The user can purposefully go through the available databases according to sensory characteristics and have the recipes of the compositions displayed. The recipes, when they do not possess the required sensory characteristics, can be modified with the help of a modification procedure. Multiple new recipes are thereby created which should suffice the desired sensory characteristics. The previously existing base compositions and their sensory evaluations constitute the basis of the modification procedure. The investigation and analysis of these data, as well as the mode of operation of the modification procedure are further described hereinafter.

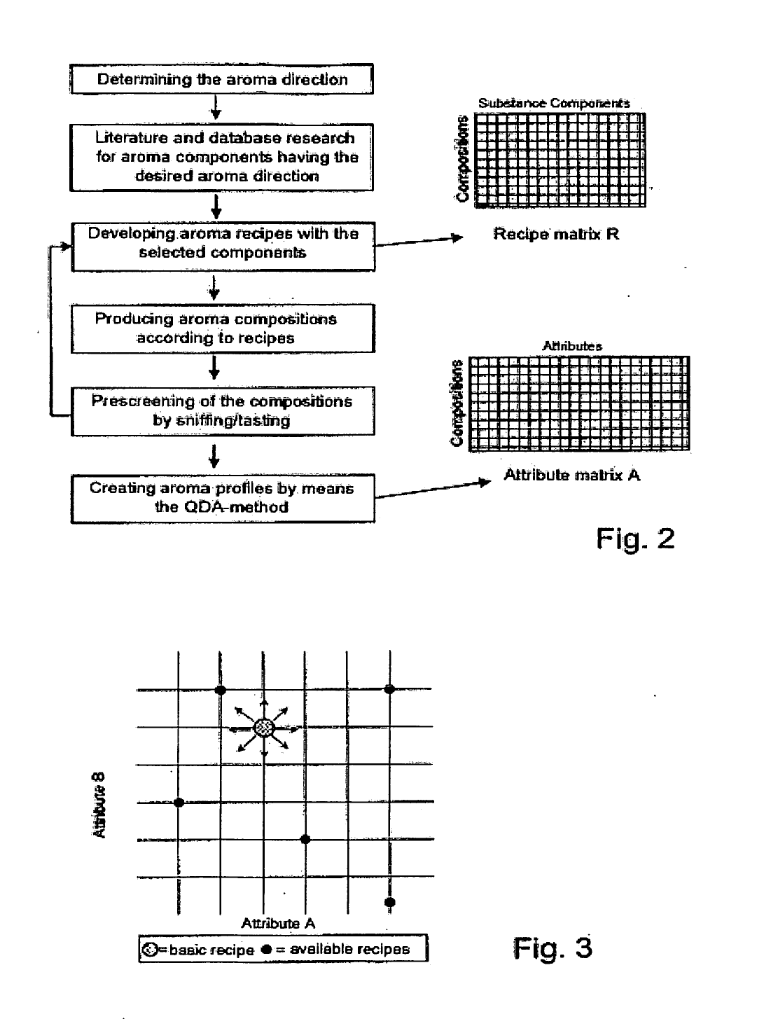

In practical applications it has proven to be of value to regard groups of compositions as so-called “modules”, whereby each of the modules is associated to a desired fragrance or aroma direction. The development of such a module is illustrated in FIG. 2. In order to create a module of the aroma of mango for instance, one first goes through technical literature and databases for components that have already been used in mango aromas or are naturally present in the fruit. Following a successful selection of for example 10 to 20 of such substance components, a group of compositions is prepared, wherein each time a few substance components are mixed with one another.

Depending on the field of application, the usual solvents, carrier substances and the like are also mixed in it besides the aroma components. The substance components are dosed in reagent glasses, which contain 8 to 15 grams, with the device described here and whereby up to 64 compositions can be manufactured simultaneously. Each composition manufactured this way is characterized by a recipe vector which indicates the proportions of the substance components used to create the composition.

The creation of for example 14 compositions K₁ to K₁₄ out of for instance 33 substance components S₁ to S₃₃ is represented in the following algebraic notation:
(K)=R(S) (1)
whereby the composition vector (K) is a column vector of dimension 4 and the substance component vector (S) is a column vector of dimension 33, and whereby the recipe matrix R is a matrix with 14 rows and 33 columns. The matrix element Rᵢⱼ represents the proportion of the substance components Sᵢ in the composition Kᵢ. The i-th row of the recipe matrix R can also interpreted as row vector (Rᵢ)^{T}, which represents the composition of composition Kᵢ, why (Rᵢ)^{T} is also designated as recipe vector of the composition Kᵢ. (row vectors are represented with the index T for “transported” in the notations used here).

A section of a recipe matrix with proportions in weight percentage is hereinafter displayed in table 1.

TABLE 1
Extract of a recipe matrix

| | S1 | S2 | | | | |
|---|---|---|---|---|---|---|
| | 2-isopropyl-4- | 3-hexenyl- | | S10 | | S33 |
| | methylthiazol | acetate | . . . | ethanol | . . . | vanillin |
| K1 | 0.0072 | 0 | | 99.2267 | . . . | 0 |
| K2 | 0.0066 | 0 | | 99.2079 | . . . | 0.0023 |
| . | . | . | | . | . . . | . |
| . | . | . | | . | . . . | . |
| . | . | . | | . | . . . | . |
| K14 | 0 | 0.1454 | | 99.4560 | . . . | 0 |

The compositions prepared in such a way are subsequently evaluated with regard to their sensory attributes. An initial discarding of compositions appearing unsuitable, as well as a refinement of compositions appearing suitable can be advantageously carried out in an initial phase. For this purpose, the compositions are sniffed with regard to their aroma characteristic. The recipes of the clearly recognizable mango aromas are refined, produced and tested again. The good mango aromas are afterwards tasted in an acidic sugared water solution. It can happen that good-smelling aromas do not taste well accordingly and are thus to be eliminated.

A quantitative evaluation of sensory attributes is carried out for the “best” mango aromas selected in the above manner, whereby this is advantageously implemented in a specialized sensor technology laboratory. An associated attribute vector is created for each composition, which corresponds to the evaluation results of the individual sensory attributes. Analogously to the recipe vectors (Rᵢ)^{T} introduced above, the attribute vector of a composition Kᵢ can be written as row vector (Aₘ)^{T}, and the attribute vectors of a group of compositions can be . . . represented as attribute matrix A, whereby the matrix element Aᵢₘ represents the characteristic of the attribute m in the composition Kᵢ. An extract of an attribute matrix with characteristic specifications on a norm scale from 0 to 15 is hereinafter represented in table 2.

TABLE 2
Extract of an attribute matrix

| | A1 | A2 | | A58 |
|---|---|---|---|---|
| | bloomy in the | fruity in the | | wooden in the |
| | aroma | aroma | . . . | aroma |
| K1 | 6.92 | 4.39 | | 2.03 |
| K2 | 7.54 | 4.75 | | 2.18 |
| . | . | . | | . |
| . | . | . | | . |
| . | . | . | | . |
| K14 | 6.43 | 3.63 | | 2.97 |

A factor analysis (in English also called “principal component analysis (PCA)”) is advantageously carried out in the sense of a data reduction. Attributes are thereby checked for similarities in their structure within the attribute matrix. For each extracted factor one attribute is selected that has a high factor loading on the one hand and makes most sense for the aroma direction on the other hand. Only the selected attributes can be purposefully changed later on in the framework of the modification process. Hence, mainly attributes that have a positive effect on the considered aroma and the considered fragrance, respectively are selected. It appears hardly desirable for instance to modify an existing mango aroma later on towards a stronger moldiness or woodiness. Approximately ten sensory attributes are selected per module in practice. Accordingly, the dimensionality of the attribute vectors (Aₘ)^{T} is reduced, wherein the number of vector components is for instance reduced from 50 to 10.

The used recipe vectors, as well as the selected attribute vectors are stored in a composition database in such a way that the vectors associated to each composition can be retrieved in relation to one another and to the composition.

Individual points are determined in a multidimensional “attribute space” by means of the data collection described above, whereby each composition of a module corresponds to a point in said attribute space. This is schematically represented in FIG. 3 for compositions at a level clamped by two attributes. The sensory attributes of the prepared compositions, with regard to their individual attributes, should feature the largest possible dispersion in order to purposefully modify the attributes.

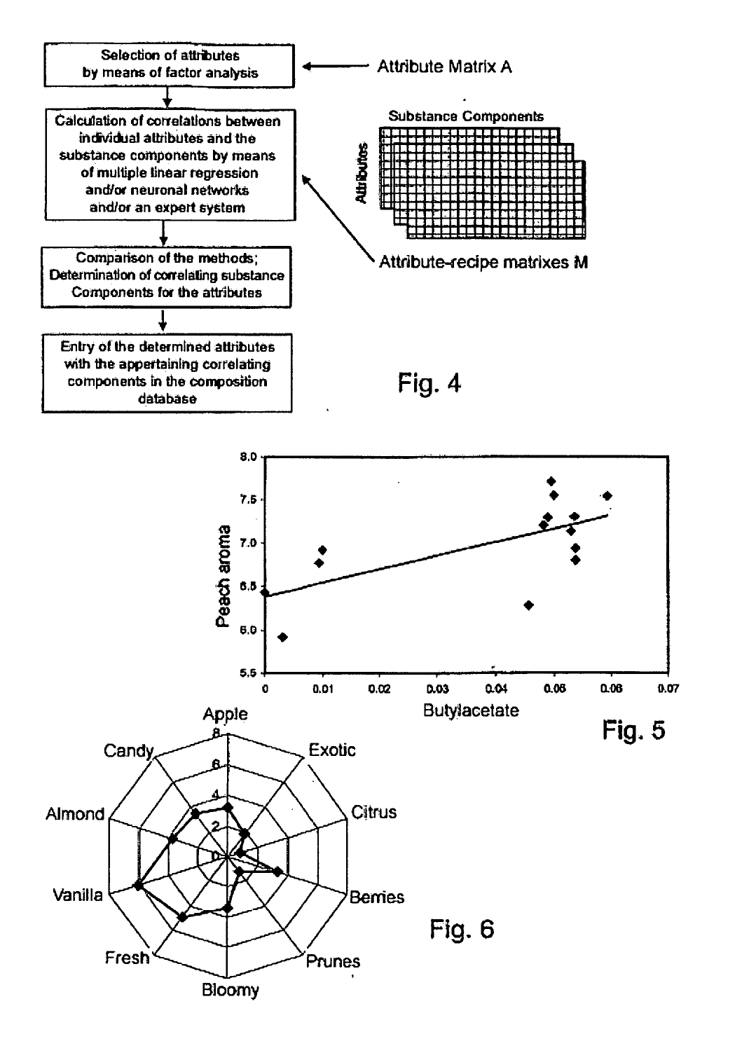

An attribute recipe matrix M is created for the relevant module in view of a modification of an existing composition. The matrix element Mₘⱼ indicates how strong the characteristic of the attribute k is specified by the proportion of the substance components Sⱼ. These relations are for instance established by means of multiple linear regression and/or neuronal networks and/or by means of an expert system. The results, which were obtained through different methods, are advantageously compared with one another and adjusted if needed. This process is schematically represented in FIG. 4. In addition, the principle to determine a matrix element M is illustrated in FIG. 5. The characteristic of the attribute “bloomy in the aroma” is to be applied against the proportion of the substance components “butylacetate” for each of the 14 components of a module. The trend line that is established through linear regression shows that the attribute peach aroma is stronger in form with increasing proportions of butylacetate.

The objective of the aforementioned procedure is to elicit substance components which have a positive or negative leverage effect on the attribute of interest. A positive leverage effect means that the increase of the proportion of the substance components concerned in an aroma recipe results in a strengthened sensory perception of the attribute of interest. A negative leverage effect signifies on the other hand that the proportion of the substance components concerned must be lowered in order to strengthen the sensory perception of the attribute of interest.

The attribute recipe matrix M can be regarded as matrix representation of an operator that effects a transformation from recipe vectors to attribute vectors at least in one local region of the attribute space. This can be formally expressed by the following equation:
(A)=M(R) (2)
wherein (A) and (R) are now the attribute and recipe vectors in column representation. Equation (2) produces the relevant attribute vector (Aᵢ) for an already characterized composition Kᵢ with relevant recipe vector (Rᵢ). The required locality of the above transformation means that equation (2) also applies for a composition Kᵢ that is slightly modified compared to the composition Kᵢ as a good approximation. Stated differently, this means that the application of calculation rule (2) to a recipe vector (Rᵢ), which is slightly modified compared to (Rᵢ), produces a calculated modified attribute vector, which corresponds to attribute vector (Aᵢ) of the modified composition Kᵢ as a good approximation. If a new composition with the specified attribute characteristic is sought after, the problem that is inverse to the procedure just described needs to be solved in principle. It is now the desired attribute vector (Aₛₒₗₗ) that is pre-specified, . . . and an associated recipe vector (Rₛₒₗₗ) is sought after which can be regarded as manufacturing specification for the sought after composition. A previously characterized composition, the attribute characteristic of which is as close as possible to the desired one, will be advantageously used for this search. In other words, a modification of an already characterized composition Kᵢₛₜ with recipe vector Rᵢₛₜ and attribute vector Aᵢₛₜ is carried out.

The modification process can be implemented as so-called “trial and error” procedure in the simplest case, i.e. a plurality of new recipe vectors can for instance be produced in the surrounding of (Rᵢₛₜ) with the help of a random generator and can calculate its associated attribute vectors by using equation (2). This would have to be repeated until an attribute vector is found that is sufficiently nearby the desired attribute vector (Aₛₒₗₗ). It is, however, more useful for the modification procedure to use a statistical test planning. A possible course of action is further clarified hereinafter.

As a rule, four to ten relevant substance components are determined per attribute. They are divided into the categories 1 to 3 according to their positive and negative leverage effect, whereby category 1 corresponds to the largest leverage effect and category 3 to the smallest leverage effect. Only one positive and one negative substance component is each time allocated to category 1 and 2, while multiple substance components can be allocated to category 3.

Table 3 shows for instance an extract of the results of a data evaluation from a module for apple aroma. The attributes “fresh in the taste” and “bloomy in the aroma” and the substance components elicited for this purpose are be listed, whereby the substance components are listed in codes.

If the substance component C335 is for instance added to an apple recipe or the substance component C8 is diminished therein, this recipe should be more bloomy in smell than the basic recipe.

TABLE 3
Extract of the data evaluation of a module for apple aroma

| | | fresh in | bloomy in |
|---|---|---|---|
| | | the taste | the aroma |
| | | Substance | Substance |
| | | components | compon. |
| Positive leverage | 1^{st} category | C13 | C335 |
| effect | 2^{nd} category | C11 | C345 |
| | 3^{rd} category | | C21 |
| | | | C164 |
| | | | C348 |
| Negative leverage | 1^{st} category | C8 | C163 |
| effect | 2^{nd} category | C350 | C8 |
| | 3^{rd} category | C12 | C11 |
| | | C14 | C12 |
| | | C74 | C167 |
| | | C163 | C341 |
| | | C345 | C423 |

As described above, a given recipe can be selected and can afterwards purposefully strengthen the characteristic of a certain attribute through its modification. Up to 14 new recipes are thereby for instance produced according to a specially developed test planning. The test planning provides for the substance components originating from the data evaluation to be assigned to the basic recipe or to be reduced. The process of the test planning is illustrated in table 4. The concentrations of the substance components with a positive leverage effect are increased in the first four recipes, and the concentrations of the substance components with a negative leverage effect are reduced in recipes 5 to 8. Only the substance components that are contained in the basic recipe can be reduced. In other words, recipe number 6 is not generated if the substance component with negative leverage effect of category 2 is not contained in the basic formulation. On the other hand, substance components with positive leverage effect are always added. The recipes 9 to 14 are created by the combination of the first eight actions.

TABLE 4
Statistics test planning

| Recipe | | |
|---|---|---|
| no. | Actions | Description |
| 1 | A1 | Addition of the category 1 components |
| 2 | A2 | Addition of the category 2 components |
| 3 | A3 | Addition of the category 1 & 2 components |
| 4 | A4 | Addition of the components of all categories |
| 5 | S1 | Reduction of the category 1 components |
| 6 | S2 | Reduction of the category 2 components |
| 7 | S3 | Reduction of the category 1 & 2 components |
| 8 | S4 | Reduction of the components of all categories |
| 9 | A4 & S4 | Action A4 & S4 together |
| 10 | A4 & S3 | Action A4 & S3 together |
| 11 | A3 & S4 | Action A3 & A4 together |
| 12 | A1 & S1 | Action A1 & S1 together |
| 13 | A2 & S2 | Action A2 & S2 together |
| 14 | A3 & S2 | Action A3 & S2 together |

According to this, the test planning shows which substance components must be increased or reduced. The absolute measure of these changes, however, must be individually calculated for each substance component and is implemented as follows.

First of all, the difference between the maximum used proportion Rₘₐₓ and the minimum used proportion Rₘᵢₙ is determined for each substance component across all recipes of the module considered module.

The result is divided by the difference between maximum characteristic Aₘₐₓ and the minimum characteristic Aₘᵢₙ, of an attribute through all recipes of the considered module:
x₁₌(Rₘₐₓ−Rₘᵢₙ)/(Aₘₐₓ−Aₘᵢₙ) (3)

The proportion Rᵢₛₜ, of the substance components, which is used in the basic recipe, is divided by the sensory evaluation of the attribute of the selected recipe in an additional step.
X₂₌Rᵢₛₜ/Aᵢₛₜ (4)

This calculation is not carried out when the substance components are not available in the basic recipe, since Rᵢₛₜ is equal to zero then.

The average value of both values calculated above is determined in the following step.
x=(x₁+x₂)/2 (5)

This calculation is not carried out when the second calculation is omitted. In this case, x=x₁.

The last step consists of multiplying the difference between the desired attribute characteristic Aₛₒₗₗ and the sensory evaluation Aᵢₛₜ of the attribute of the selected recipe with the result of equation (5):
ΔR=x(Aₛₒₗₗ−Aᵢₛₜ) (6)

The result ΔR is now the proportion of the considered substance component, which is added to the basic recipe or reduced in the basic recipe. In the event that ΔR is negative and the amount of ΔR exceeds the proportion Rᵢₛₜ of the substance component in the basic recipe, this substance component will be taken out of the recipe.

The above calculation is designed for the strengthening of an attribute but can also be used to weaken an attribute in an analogous manner.

An example for the visualization of the attribute vector of an individual composition is illustrated in FIG. 6 in the form of a polar diagram (also called “spider web”). To each attribute is associated a beam section that emanates from a mutual center and the length of which is a measure for the characteristic of the attribute concerned. The beams are thereby placed at an equal distance and in an angular manner. The attribute “citrus” has the weakest impression and the attributes “vanilla” and “fresh” have the strongest impression in the shown composition. Such a representation is well suited for an interactive modification of compositions. The polar diagram that is displayed on the monitor can for instance be purposefully changed by means of a computer mouse, thus providing a modified attribute vector for a desired new composition.

In the claims:

1. Method for producing a fragrance and/or aroma composition, characterized by using a composition database that is comprised of recipe vectors and attribute vectors associated with a group of base compositions that can be manufactured by mixing predetermined substance components, whereby each recipe vector specifies the proportions of the substance components that are required for the creation of the associated base composition and whereby each attribute vector specifies the evaluation results with regard to selected sensory attributes of the associated base composition, and whereby the method consists of the following steps:
a) specifying a target attribute vector;
b) determining an operator which effects a transformation from recipe vectors to attribute vectors at least in a surrounding of the target attribute vector;
c) establishing a target recipe vector with the proviso that it is transformed to the target attribute vector by using said operator; and
d) mixing the predetermined substance components with proportions according to the target recipe vector.

2. Method according to claim 1, wherein the composition database is produced by the following steps:
a) preparing the group of base compositions by mixing the substance components in proportions according to a recipe vector that is associated to each base composition;
b) quantitatively evaluating each one of the base compositions with regard to the selected sensory attributes and creation of the associated attribute vector; and
c) creating the composition database by storing the recipe vectors and attribute vectors in such a way that the vectors that are associated to each base composition can be retrieved in relation to one another and to the base composition.

3. Method according to claim 1, wherein the evaluation of the sensory attributes is based on quantitative descriptive analysis.

4. Method according to claim 1, wherein the attributes used to create the attribute vectors are selected by means of a factor analysis.

5. Method according to claim 1, wherein the operator is established by means of one of multiple regression, neuronal networks, and an expert system.

6. Method according to claim 1, wherein the target recipe vector is determined by means of statistical test planning.

7. Method according to claim 1, wherein the target attribute vector is determined through the attribute evaluation of a predetermined composition.

8. Method according to claim 1, wherein attribute vectors are represented in the form of polar diagrams.

9. Device for carrying out the method according to claim 1, with a data processing unit, as well as with a mixing device that is controlled by it, whereby the data processing unit comprises means for the entry, storage and retrieval of at least one composition database, as well as means for the entry of attribute vectors, means for the calculation of target recipe vectors and means for the transfer of control signals that are shaped according to the recipe vectors to the mixing device, and whereby mixing the device features the following components:
a) a plurality of storage containers that can be filled with individual substance components;
b) a plurality of receptacles;
c) a controllable feeding device to bring predetermined quantities of individual substance components from the corresponding storage containers to the receptacles for the creation of one of a fragrance and aroma composition.

10. Method according to claim 2, wherein the evaluation of the sensory attributes is based on quantitative descriptive analysis.

11. Method according to claim 3, wherein the attributes used to create the attribute vectors are selected by means of a factor analysis.

12. Method according to claim 4, wherein the operator is established by means of one of multiple regression, neuronal networks, and an expert system.

13. Method according to claim 5, wherein the target recipe vector is determined by means of statistical test planning.

14. Method according to claim 2, wherein the target attribute vector is determined through the attribute evaluation of a predetermined composition.

15. Method according to claim 3, wherein the target attribute vector is determined through the attribute evaluation of a predetermined composition.

16. Method according to claim 4, wherein the target attribute vector is determined through the attribute evaluation of a predetermined composition.

17. Method according to claim 7, wherein attribute vectors are represented in the form of polar diagrams.

18. Method according to claim 15, wherein attribute vectors are represented in the form of polar diagrams.

19. Method according to claim 16, wherein attribute vectors are represented in the form of polar diagrams.

20. Method according to claim 13, wherein attribute vectors are represented in the form of polar diagrams.
